(19) United States
(12) Patent Application Publication
(10) Pub. No.: US 2026/0313653 A1
(43) Pub. Date: Oct. 8, 2026

(54) PHYSICAL UPLINK CONTROL CHANNEL SEQUENCES SUPPORTING FREQUENCY SELECTIVITY

(71) Applicant: QUALCOMM Incorporated, San Diego, CA (US)

(72) Inventors: Akash Sandeep DOSHI, San Diego, CA (US); June NAMGOONG, San Diego, CA (US); Wei YANG, San Diego, CA (US)

(21) Appl. No.: 19/636,051

(22) Filed: Apr. 1, 2026

Related U.S. Application Data
(60) Provisional application No. 63/782,417, filed on Apr. 2, 2025.

(51) Int. Cl. H04W 72/21; H04W 72/0453

(52) U.S. Cl. CPC H04W 72/21; H04W 72/0453

(57) ABSTRACT

Various aspects of the present disclosure generally relate to wireless communication. In some aspects, a user equipment (UE) may receive, from a network node, a configuration that indicates a set of sequences associated with physical uplink control channel (PUCCH) communications in accordance with a metric associated with the set of sequences satisfying a threshold associated with a channel frequency selectivity. The UE may transmit, to the network node, a PUCCH message in accordance with the set of sequences. Numerous other aspects are described.

### CROSS-REFERENCE TO RELATED APPLICATION

This patent application claims priority to U.S. Provisional Patent Application No. 63/782,417, filed on Apr. 2, 2025, entitled “PHYSICAL UPLINK CONTROL CHANNEL SEQUENCES SUPPORTING FREQUENCY SELECTIVITY,” and assigned to the assignee hereof. The disclosure of the prior application is considered part of and is incorporated by reference into this patent application.

### FIELD OF THE DISCLOSURE

Aspects of the present disclosure generally relate to wireless communication and specifically relate to techniques, apparatuses, and methods associated with evaluating physical uplink control channel sequences to support channel frequency selectivity.

### DESCRIPTION OF THE RELATED TECHNOLOGY

Wireless communication systems are widely deployed to provide various services, which may involve carrying or supporting voice, text, other messaging, video, data, or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, or device transmit power, among other examples). Such multiple-access RATs are supported by technological advancements that have been adopted in various telecommunication standards, which define common protocols that enable different wireless communication devices to communicate on a local, municipal, national, regional, or global level. An example telecommunication standard is New Radio (NR). NR, which also may be referred to as 5G, is part of a continuous mobile broadband evolution promulgated by the Third Generation Partnership Project (3GPP). As the demand for connectivity continues to increase, further improvements in NR may be implemented, and other RATs, such as 6G and beyond, may be introduced to enable new applications and facilitate new use cases.

In wireless communication systems, a user equipment (UE) may transmit control information via a physical uplink control channel (PUCCH) to a network node, and the control information may include hybrid automatic repeat request acknowledgments, scheduling requests, and other signaling to the network node. PUCCH sequences may be designed to ensure efficient and reliable communication in various deployment scenarios. These sequences may support the transmission of multiple bits of payload, with each payload sequence being mapped to a set of resource elements that are subsequently transmitted over the PUCCH.

### SUMMARY

The systems, methods, and devices of this disclosure each have several innovative aspects, no single one of which is solely responsible for the desirable attributes disclosed herein.

Some aspects described herein relate to a user equipment (UE). The UE may include a processing system. The processing system may include one or more processors and one or more code-storing memories coupled with the one or more processors. The processing system may be configured to cause the UE to receive, from a network node, a configuration that indicates a set of sequences associated with physical uplink control channel (PUCCH) communications in accordance with a metric associated with the set of sequences satisfying a threshold associated with a channel frequency selectivity. The processing system may be configured to cause the UE to transmit, to the network node, a PUCCH message in accordance with the set of sequences.

Some aspects described herein relate to a network node. The network node may include a processing system. The processing system may include one or more processors and one or more code-storing memories coupled with the one or more processors. The processing system may be configured to cause the network node to transmit, to a UE, a configuration that indicates a set of sequences associated with PUCCH communications in accordance with a metric associated with the set of sequences satisfying a threshold associated with a channel frequency selectivity. The processing system may be configured to cause the network node to receive, from the UE, a PUCCH message in accordance with the set of sequences.

Some aspects described herein relate to a method of wireless communication performed by a UE. The method may include receiving, from a network node, a configuration that indicates a set of sequences associated with PUCCH communications in accordance with a metric associated with the set of sequences satisfying a threshold associated with a channel frequency selectivity. The method may include transmitting, to the network node, a PUCCH message in accordance with the set of sequences.

Some aspects described herein relate to a method of wireless communication performed by a network node. The method may include transmitting, to a UE, a configuration that indicates a set of sequences associated with PUCCH communications in accordance with a metric associated with the set of sequences satisfying a threshold associated with a channel frequency selectivity. The method may include receiving, from the UE, a PUCCH message in accordance with the set of sequences.

Some aspects described herein relate to a non-transitory computer-readable medium that stores a set of instructions for wireless communication by a UE. The set of instructions, when executed by one or more processors of the UE, may cause the UE to receive, from a network node, a configuration that indicates a set of sequences associated with PUCCH communications in accordance with a metric associated with the set of sequences satisfying a threshold associated with a channel frequency selectivity. The set of instructions, when executed by one or more processors of the UE, may cause the UE to transmit, to the network node, a PUCCH message in accordance with the set of sequences.

Some aspects described herein relate to a non-transitory computer-readable medium that stores a set of instructions for wireless communication by a network node. The set of instructions, when executed by one or more processors of the network node, may cause the network node to transmit, to a UE, a configuration that indicates a set of sequences associated with PUCCH communications in accordance with a metric associated with the set of sequences satisfying a threshold associated with a channel frequency selectivity. The set of instructions, when executed by one or more processors of the network node, may cause the network node to receive, from the UE, a PUCCH message in accordance with the set of sequences.

Some aspects described herein relate to an apparatus for wireless communication. The apparatus may include means for receiving, from a network node, a configuration that indicates a set of sequences associated with PUCCH communications in accordance with a metric associated with the set of sequences satisfying a threshold associated with a channel frequency selectivity. The apparatus may include means for transmitting, to the network node, a PUCCH message in accordance with the set of sequences.

Some aspects described herein relate to an apparatus for wireless communication. The apparatus may include means for transmitting, to a UE, a configuration that indicates a set of sequences associated with PUCCH communications in accordance with a metric associated with the set of sequences satisfying a threshold associated with a channel frequency selectivity. The apparatus may include means for receiving, from the UE, a PUCCH message in accordance with the set of sequences.

Aspects of the present disclosure may generally be implemented by or as a method, apparatus, system, computer program product, non-transitory computer-readable medium, user equipment, network node, wireless communication device, or processing system as substantially described in the Detailed Description with reference to, and as illustrated by, the accompanying drawings and appendix. Details of one or more implementations of the subject matter described in this disclosure are set forth in the accompanying drawings, appendix, and the description below. Other features, aspects, and advantages will become apparent from the description, the drawings, and the claims. Note that the relative dimensions of the following figures may not be drawn to scale.

While aspects and embodiments are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, embodiments and/or uses may come about via integrated chip embodiments and other non-module-component based devices (e.g., end-user devices, vehicles, communication devices, computing devices, industrial equipment, retail/purchasing devices, medical devices, AI-enabled devices, etc.). While some examples may or may not be specifically directed to use cases or applications, a wide assortment of applicability of described innovations may occur. Implementations may range in spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also necessarily include additional components and features for implementation and practice of claimed and described embodiments. For example, transmission and reception of wireless signals necessarily includes a number of components for analog and digital purposes (e.g., hardware components including antennas, RF-chains, power amplifiers, modulators, buffers, processor(s), interleavers, adders/summers, etc.). It is intended that innovations described herein may be practiced in a wide variety of devices, chip-level components, systems, distributed arrangements, end-user devices, etc. of varying sizes, shapes, and constitution.

### BRIEF DESCRIPTION OF THE DRAWINGS

FIG. 1 is a diagram illustrating an example of a wireless communication network.

FIG. 2 is a diagram of an example associated with a metric for evaluating physical uplink control channel (PUCCH) sequences for supporting channel frequency selectivity.

FIG. 3 is a diagram of an example associated with a metric for evaluating PUCCH sequences for supporting channel frequency selectivity.

FIG. 4 is a diagram illustrating an example process performed at a user equipment (UE) or an apparatus of a UE.

FIG. 5 is a diagram illustrating an example process performed at a network node or an apparatus of a network node.

FIG. 6 is a diagram of an example apparatus for wireless communication.

FIG. 7 is a diagram of an example apparatus for wireless communication.

### DETAILED DESCRIPTION

In wireless communication systems, a user equipment (UE) may transmit control information via a physical uplink control channel (PUCCH) to a network node, and the control information may include hybrid automatic repeat request (HARQ) information, scheduling requests (SRs), and other signaling to the network node. PUCCH sequences may be designed to ensure efficient and reliable communication in various deployment scenarios. These sequences may support the transmission of multiple bits of payload, with each payload sequence being mapped to a set of resource elements (REs) that are subsequently transmitted over the PUCCH. For example, a PUCCH payload sequence may include three payload bits (e.g., 2 HARQ acknowledgement bits and one SR bit), and each payload sequence may be mapped to 12 REs.

In some examples, a PUCCH sequence (e.g., for a PUCCH format 0) may be represented by x(n), as shown by Equation 1 below,

$$x ( n ) = {e}^{j a n} \cdot {e}^{j {φ}_{K} ( n ) \frac{π}{4}} \qquad ( 1 )$$

where e^{jαn} is a first portion associated with phase ramping (e.g., across 12 tones), with n representing a tone index (e.g., with 0≤n≤11 for 12 tones) and α being a cyclic shift value (e.g., α∈

$$\frac{π}{6}$$

·{0, 1, 2, . . . , 11}), and where

$${e}^{j {φ}_{k} ( n ) \frac{π}{4}}$$

is a second portion (e.g., a computer-generated sequence) associated with interference mitigation, with φₖ being associated with a cell identifier. In some cases, the first portion may be designed for inter-UE or intra-UE use, while the second portion may be designed for inter-cell use and may be associated with implementing quadrature phase shift keying (QPSK).

In some examples, PUCCH sequences may be designed to maintain orthogonality to mitigate inter-cell and intra-cell interference. For example, different sequences, each having a different value for α (e.g., of 12 potential 12-by-1 sequences) with a fixed value of k (e.g., associated with a cell identifier), may all be orthogonal to each other. In some examples, using sequences that are orthogonal to each other may achieve a target bit error rate (BER), particularly in scenarios with frequency-flat channels and high signal-to-noise ratios (SNRs).

In some cases, however, maintaining orthogonality between PUCCH sequences may not be sufficient to achieve a target BER. For example, a channel having high frequency selectivity may experience BERs higher than a channel with low frequency selectivity, even when orthogonal PUCCH sequences are used, as highly frequency selective channels may experience channel conditions that vary significantly across the frequency spectrum. In some cases, for instance, sequences based on discrete Fourier transform (DFT) matrices may degrade significantly under highly frequency-selective channels, leading to errors in non-coherent detection.

Various aspects relate generally to PUCCH sequences that support high channel frequency selectivity. Some aspects more specifically relate to a metric to evaluate a performance of PUCCH sequences in relation to channel frequency selectivity. In some aspects, the metric may be computed for a set of PUCCH sequences, and the PUCCH sequences may be used when the metric satisfies a threshold associated with a channel frequency selectivity. For example, a set of values may be computed from a set of sequence pairs, where each sequence pair of the set of sequence pairs includes two distinct sequences of the set of PUCCH sequences. In some aspects, the metric satisfying the threshold may include a maximum value from the set of values satisfying the threshold. In some examples, the set of PUCCH sequences may include 2^{k} sequences, where k may be the quantity of information bits associated with a PUCCH transmission (e.g., for a corresponding PUCCH format). In some aspects, the evaluation of each value in the set of values may involve computing an elementwise multiplication of a frequency-domain channel representation including a plurality of channel elements with a first sequence of a respective sequence pair, taking a dot product of the elementwise multiplication with the conjugate of a second sequence of the respective sequence pair, and dividing a squared norm of the dot product by the squared norm of a sum of the plurality of channel elements. In some examples, the maximum value may be computed for all delay values associated with the frequency-domain channel representation that are lower than a cyclic prefix length. In some aspects, a network node may be configured to transmit a configuration indicating the PUCCH sequences in accordance with the metric for the PUCCH sequences satisfying the threshold value. Accordingly, the UE may transmit a PUCCH message to the network node in accordance with the set of PUCCH sequences.

Particular aspects of the subject matter described in this disclosure can be implemented to realize one or more of the following potential advantages. In some examples, by utilizing a set of PUCCH sequences that satisfy a metric threshold, the UE may transmit PUCCH messages with enhanced transmission fidelity and with a BER below a target BER, even under high frequency-selective channel conditions. For example, the techniques for computing the metric may account for channel frequency selectivity, which may facilitate the assessment of PUCCH sequence suitability across various levels of frequency selectivity, providing a versatile approach for improving network performance or evaluating candidate PUCCH sequences. By configuring the network node to transmit configurations indicating PUCCH sequences meeting the metric threshold, the network node may have more precise control over the transmission parameters for the UE, which may conserve network resources by reducing retransmissions due to errors. Additionally, by employing a method that evaluates the effectiveness of PUCCH sequences against this new metric, the network node may evaluate new PUCCH sequences more readily to improve performance in channels with different channel frequency selectivity. For example, PUCCH sequences may be generated using artificial intelligence or machine learning (AI/ML) techniques, and the performance of generated PUCCH sequences may be evaluated using the metric to select a set of PUCCH sequences for transmissions by UEs.

5G New Radio (NR) may support enhanced mobile broadband (eMBB) access, Internet of Things (IoT) networks or reduced capability (RedCap) device deployments, ultra-reliable low-latency communication (URLLC) applications, or massive machine-type communication (mMTC), among other examples. To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, sub-band full-duplex (SBFD)), multiple-subscriber implementations, high-precision positioning, radio frequency (RF) sensing, network energy savings (NES), low-power signaling and radios, or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial or aerial platforms, among other examples.

The methods, operations, apparatuses, and techniques described herein may enable one or more of the foregoing technologies or new technologies or support one or more of the foregoing use cases or new use cases.

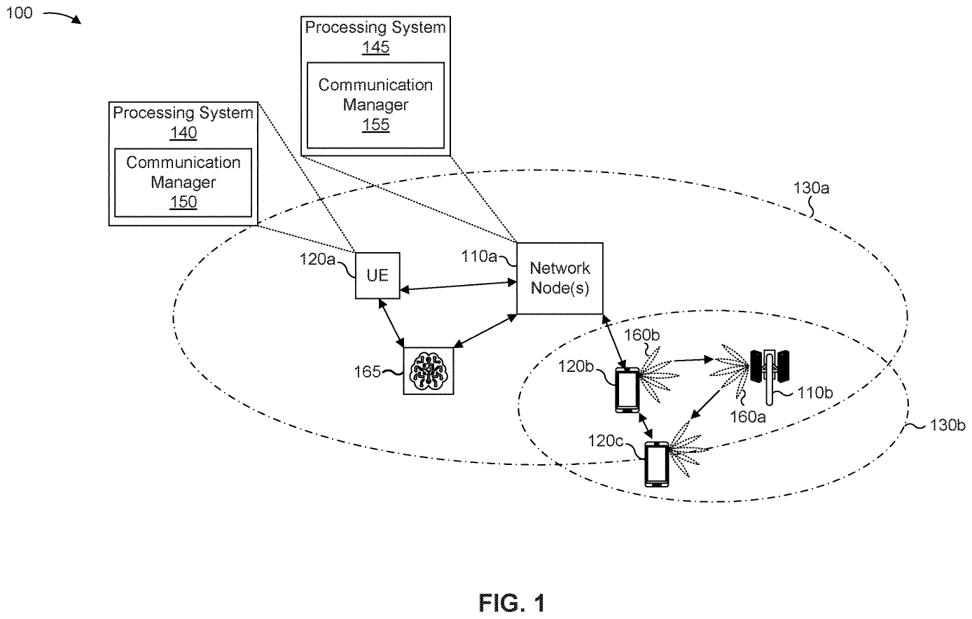

FIG. 1 is a diagram illustrating an example of a wireless communication network 100. The wireless communication network 100 may be or may include elements of a 5G network or a 6G network, among other examples. The wireless communication network 100 may include multiple network nodes 110. For example, in FIG. 1, the wireless communication network 100 includes multiple network nodes 110, including a network node 110a and a network node 110b (each of which also may be referred to herein simply as a “network node 110”). The network nodes 110 may support communications with multiple UEs 120. For example, in FIG. 1, the network nodes 110 support communication with a UE 120a, a UE 120b, and a UE 120c (each of which also may be referred to herein simply as a “UE 120”). In some examples, a UE 120 also may communicate with other UEs 120 and a network node 110 also may communicate with a core network and with other network nodes 110.

The network nodes 110 and the UEs 120 of the wireless communication network 100 communicate using the electromagnetic spectrum, which may be subdivided into various licensed or unlicensed operating bands, frequency ranges, component carriers, or channels that define associated frequencies available for communications. In some examples, each of the network nodes 110 and the UEs 120 may communicate using one or multiple component carriers in one or more operating bands or ranges. Typically, various operating bands are defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “sub-6 GHz” band in some documents and articles. Similarly, FR2 is often referred to (interchangeably) as a “millimeter wave” band in some documents and articles.

A network node 110 or a UE 120 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or comprise a processing system. As shown in FIG. 1, each UE 120 includes a processing system 140 and each network node 110 includes a processing system 145. A processing system (for example, the processing system 140 or the processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 and the processing system 145 may each include memory circuitry in the form of one or multiple memory devices, memory blocks, memory elements, or other discrete gate or transistor logic or circuitry, each of which may include or implement tangible storage media, such as random-access memory, or read-only memory, or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors. One or more of the memories may individually or collectively store processor-executable code or instructions (such as software) (for example, which may be referred to as “one or more code-storing memories” or “code-storing memory circuitry”). For example, “code-storing memory” or “code-storing memory circuitry” refers to memory (or memory circuitry) that is configured to store processor-executable code or instructions. The processor-executable code or instructions, when executed by one or more of the processors, may configure one or more of the processors (or processing circuitry) to perform various functions or operations described herein. Additionally, or alternatively, in some examples, one or more of the processors may be configured to perform various functions or operations described herein without requiring configuration by software. Software shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 and the processing system 145 may each include or be coupled with one or more modems (such as a cellular (for example, a 5G or 6G compliant) modem). In some examples, one or more processors of the processing system 140 or the processing system 145 may include or implement one or more of the modems. The processing system 140 and the processing system 145 also may include or be coupled with multiple radios (collectively “the radio”), multiple RF chains, or multiple transceivers, each of which may in turn be coupled with one or more of multiple antennas. In some examples, one or more processors of the processing system 140 or the processing system 145 may include or implement one or more of the radios, RF chains, or transceivers. An RF chain may include one or more filters, mixers, oscillators, amplifiers, analog-to-digital converters (ADCs), or other devices that convert between an analog signal (such as for transmission or reception via an air interface) and a digital signal (such as for processing by the processing system 140 or by the processing system 145).

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device, such as the network node 110 and the UE 120.

A network node 110 may be, may include, or also may be referred to as an NR network node, a 5G network node, a 6G network node, a Node B, a gNB, an access point (AP), a transmission reception point (TRP), a network entity, a network element, a network equipment, or another type of device, component, or system included in a radio access network (RAN). In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may include a single standalone base station or a single TRP that operates with a full radio protocol stack to enable or facilitate communication between a UE 120 and a core network of the wireless communication network 100.

Alternatively, a network node 110 may be a disaggregated network node 110 (sometimes referred to as a disaggregated base station), having a disaggregated architecture, meaning that the network node 110 may operate with a radio protocol stack that is physically distributed or logically distributed among two or more nodes in the same geographic location or in different geographic locations. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The disaggregated network nodes 110 of the wireless communication network 100 may include one or more central units (CUs), one or more distributed units (DUs), and one or more radio units (RUs). A CU may host one or more higher layers, such as a radio resource control (RRC) layer, a packet data convergence protocol (PDCP) layer, and a service data adaptation protocol (SDAP) layer, among other examples. A CU can communicate with a core network either directly (for example, via a backhaul link) or indirectly (for example, via one or more disaggregated control units, such as a non-real-time (Non-RT) RAN intelligent controller (RIC) associated with a Service Management and Orchestration (SMO) framework or a near-real-time (Near-RT) RIC). A DU may host one or more of a radio link control (RLC) layer, a medium access control (MAC) layer, or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, or physical random access channel (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. A CU may communicate with one or more DUs via respective midhaul links, such as via F1 interfaces. Each of the DUs may communicate with one or more RUs via respective fronthaul links. Each of the RUs may communicate with one or more UEs 120 via respective RF access links. In some deployments, a UE 120 may be simultaneously served by multiple RUs.

In some examples, a single network node 110 may include a combination of one or more CUs, one or more DUs, or one or more RUs. In some examples, a CU, a DU, or an RU may be implemented as a virtual unit, such as a virtual central unit (VCU), a virtual distributed unit (VDU), or a virtual radio unit (VRU), among other examples, which may be implemented as a virtual network function, such as in a cloud deployment (for example, an open cloud (O-Cloud) platform). An SMO framework may support RAN deployment and provisioning of non-virtualized and virtualized network elements.

In some examples, the wireless communication network 100 may be a heterogeneous network that includes network nodes 110 of various types. Different types of network nodes 110 may generally operate on the same or different operating bands, transmit at different power levels, or serve different coverage areas, each of which may be referred to as or associated with a particular cell 130 (for example, a cell 130a and a cell 130b).

The UEs 120 may be physically dispersed throughout the coverage area of the wireless communication network 100, and each UE 120 may be stationary or mobile. A UE 120 may be, may include, or also may be referred to as an access terminal, a mobile station, a client device, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, or smart jewelry), a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), an artificially intelligent robot or other device implementing artificial intelligence, a UE function of a network node, or any other suitable device or function that may communicate in the wireless communication network 100.

Some UEs 120 may be classified according to different categories in association with different complexities or different capabilities. UEs 120 in a first category may be associated with relatively low complexity or cost such as NB-IoT devices or eMTC UEs. UEs 120 in a second category may include higher complexity or cost devices, such as mission-critical IoT devices, baseline UEs, high-tier UEs, advanced UEs, full-capability UEs, or premium UEs that are capable of URLLC, eMBB, or precise positioning in the wireless communication network 100. A third category of UEs 120 may have mid-tier complexity or capabilities (for example, capabilities between that of the UEs 120 of the first category and the UEs 120 of the second category). A UE 120 of the third category may be referred to as a reduced capability UE (“RedCap UE”), a mid-tier UE, an NR-Light UE, or an NR-Lite UE, among other examples.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

Frequency domain resources may be subdivided into bandwidth parts (BWPs). A BWP may be a block of frequency domain resources (for example, a continuous set of resource blocks (RBs) within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a downlink control information (DCI) configuration to the one or more UEs 120) or reconfigured (for example, in real-time or near-real-time) according to changing network conditions in the wireless communication network 100 or specific requirements of one or more UEs 120. An active BWP defines the operating bandwidth of the UE 120 within the operating bandwidth of the serving cell.

As used herein, a downlink signal may be or include a reference signal, control information, or data. For example, downlink reference signals include a primary synchronization signal (PSS), a secondary SS (SSS), an SS block (SSB) (for example, that includes a PSS, an SSS, and a physical broadcast channel (PBCH)), a demodulation reference signal (DMRS), a phase tracking reference signal (PTRS), a tracking reference signal (TRS), and a channel state information (CSI) reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications or downlink data channel communications. A downlink control channel may be specifically used to transmit DCI from a network node 110 to a UE 120. DCI generally contains the information the UE 120 needs to identify RBs in a subsequent subframe and how to decode them, including a modulation and coding scheme (MCS) or redundancy version parameters. Different DCI formats carry different information, such as scheduling information in the form of downlink or uplink grants, slot format indicators (SFIs), preemption indicators (PIs), transmit power control (TPC) commands, HARQ information, new data indicators (NDIs), among other examples. A downlink data channel may be used to transmit downlink data (for example, user data associated with a UE 120) from a network node 110 to a UE 120. Downlink control channels may include physical downlink control channels (PDCCHs), and downlink data channels may include physical downlink shared channels (PDSCHs). Control information or data communications may be transmitted on a PDCCH and PDSCH, respectively. For example, a PDCCH can carry DCI, while a PDSCH can carry a MAC control element (MAC-CE), an RRC message, or user data, among other examples. Each PDSCH may carry one or more transport blocks (TBs) of data.

As used herein, an uplink signal may include a reference signal, control information, or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications or uplink data channel communications. An uplink control channel may be specifically used to transmit uplink control information (UCI) from a UE 120 to a network node 110. An uplink data channel may be used to transmit uplink data (for example, user data associated with a UE 120) from a UE 120 to a network node 110. Uplink control channels may include PUCCHs, and uplink data channels may include physical uplink shared channels (PUSCHs). Control information or data communications may be transmitted on a PUCCH and PUSCH, respectively. For example, a PUCCH can carry UCI, while a PUSCH can carry a MAC-CE, an RRC message, or user data, among other examples. UCI can include an SR, HARQ feedback information (for example, a HARQ acknowledgement (ACK) indication or a HARQ negative acknowledgement (NACK) indication), uplink power control information (for example, an uplink TPC parameter), or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), or measurement information (for example, a layer 1 (L1)-reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a DFT-spread-orthogonal frequency division multiplexing (OFDM) (DFT-s-OFDM) waveform or a CP-OFDM waveform) that is transmitted by the network node 110 or UE 120 over a wireless communication channel. In some examples, the network node 110 or the UE 120 (for example, using the processing system 145 or the processing system 140, respectively) may select an MCS (for example, an order of quadrature amplitude modulation (QAM), such as 64-QAM, 128-QAM, or 256-QAM, among other examples) for a downlink signal or an uplink signal. For example, the network node 110 may select an MCS for a downlink signal in accordance with UCI received from the UE 120 or may transmit, to the UE 120, an indication of an MCS to be applied for an uplink signal.

A network node 110 or a UE 120 (such as by using the processing system 145 or the processing system 140, respectively, or one or more coupled modems) may perform signal processing on the information (such as filtering, amplification, modulation, digital-to-analog conversion, an IFFT operation, multiplexing, interleaving, mapping, or encoding, among other examples) to generate a processed signal in accordance with the selected MCS. In some examples, the network node 110 or the UE 120 (for example, using the processing system 145 or the processing system 140, respectively, or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (for example, using the processing system 145 or one or more modems) may further perform spatial processing (for example, precoding) on the encoded information to generate one or more processed or precoded signals for downlink or uplink transmission, respectively. In some examples, the network node 110a or the UE 120a may perform codebook-based precoding or non-codebook-based precoding. Codebook-based precoding may involve selecting a precoder (for example, a precoding matrix) using a codebook. For example, the network node 110a may provide precoding information indicating which precoder, defined by the codebook, is to be used by the UE 120a. Non-codebook-based precoding may involve selecting or deriving a precoder based on, or otherwise associated with, one or more downlink or uplink signal measurements. The network node 110a or the UE 120a may transmit the processed downlink or uplink signals, respectively, via one or more antennas.

The network node 110a or the UE 120a may receive uplink signals or downlink signals, respectively, via one or more antennas. The network node 110a or the UE 120a (for example, using the processing system 145 or the processing system 140, respectively, or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, or decoding, among other examples), to map the received signal(s) to a sequence of binary bits (for example, received information) that estimates the information transmitted by the network node 110 or the UE 120 via the downlink or uplink signals. The network node 110a or the UE 120a (for example, using the processing system 145 or the processing system 140, respectively, or a coupled decoder or one or more modems) may decode the received information (such as by using an ECC, a decoding operation, or an FEC operation) to detect errors or correct bit errors in the received information to generate decoded information. The decoded information may estimate the information transmitted via the downlink or uplink signals.

In some examples, a UE 120 and a network node 110 may perform MIMO communication. MIMO communication generally refers to transmitting or receiving multiple signals (such as multiple layers or multiple data streams) simultaneously over the same time and frequency resources. A network node 110 or a UE 120 may communicate using single-user MIMO or multi-user MIMO (MU-MIMO), the latter of which being used by a network node 110 to simultaneously transmit signals to multiple UEs 120. MIMO techniques may involve spatial multiplexing (multi-layer transmission) or beamforming. To implement beamforming, the amplitudes or phases of signals transmitted via antenna elements may be modulated and shifted relative to each other (such as by manipulating a phase shift, a phase offset, or an amplitude) to generate one or more beams. For example, a network node 110 may generate one or more beams 160a, and a UE 120 may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with such a directional transmission or directional reception, a set of directional resources associated with a signal transmission or signal reception (for example, an angle of arrival, a horizontal direction, or a vertical direction), or a set of parameters or resources associated with one or more aspects of a directional signal, among other examples.

In some examples, a network node 110 or a UE 120 may implement massive MIMO, which may be associated with an increased (for example, “massive”) quantity of antennas at the network node 110 or at the UE 120, such as in a network implementing mmWave technology, which enables more precise beamforming or reduced interference. In some examples, the wireless communication network 100 may implement multi-TRP (mTRP) operation (including redundant transmission or reception on multiple TRPs) or non-coherent joint transmission (NC-JT).

The network node 110 and the UE 120 may establish a communication link or beam pair, and otherwise increase reliability, throughput, signal strength, or other signal properties for MIMO communications, by performing beam management operations, such as an initial beam acquisition operation, a beam refinement operation, or a beam recovery operation. For example, an initial beam acquisition operation may involve the network node 110 transmitting signals (for example, SSBs or other signals) via respective beams (for example, of the beams 160 of the network node 110) and the UE 120 receiving and measuring the signal(s) via respective beams of multiple beams (for example, from the beams 160 of the UE 120) to identify a best beam (or beam pair) for communication between the UE 120 and the network node 110. A beam refinement operation may involve a first device (for example, the UE 120 or the network node 110) transmitting signal(s) via a subset of beams (for example, identified based on, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified or defined via one or more spatial parameters, such as a transmission configuration indicator (TCI) state or a quasi co-location (QCL) parameter, among other examples.

Some aspects and techniques as described herein may be implemented, at least in part, using an artificial intelligence (AI) program (for example, referred to herein as an “AI/ML model”), such as a program that includes a machine learning (ML) model or an artificial neural network (ANN) model. The AI/ML model may be deployed at one or more devices 165 (for example, one or more network nodes 110, one or more UEs 120, one or more servers, or one or more components of a cloud computing network, among other examples). For example, in a deployment in which AI/ML functionality is performed independently at a device 165, sometimes referred to as “overlay AI/ML,” the AI/ML model (or an instance or portion of the AI/ML model) may be deployed at a UE 120 (for example, by the processing system 140), a network node 110 (for example, by the processing system 145), one or more servers, or one or more components of a cloud computing network, among other examples. Additionally, or alternatively, in a deployment where AI/ML functionality is coordinated between different devices 165, sometimes referred to as “coordinated AI/ML,” or performed at all device and network layers, sometimes referred to as “native AI/ML,” the AI/ML model (or an instance of the AI/ML model) may be deployed at multiple devices 165 (for example, a first portion of the AI/ML model may be deployed at a UE 120 and a second portion of the AI/ML model may be deployed at a network node 110). In other examples of coordinated AI/ML or native AI/ML, a first AI/ML model may be deployed at a UE 120 and a second AI/ML model may be deployed at a network node 110. The AI/ML model(s) may be configured to enhance various aspects of the wireless communication network 100 (for example, to increase privacy, reliability, or efficient use of network bandwidth, or to reduce latency, among other examples). For example, the AI/ML model(s) may be trained to identify patterns or relationships in data corresponding to the wireless communication network 100, a device, or an air interface, among other examples. The AI/ML model(s) may support operational decisions relating to one or more aspects associated with wireless communications devices, networks, or services.

Accordingly, in some examples, the AI/ML model(s) may enable AI-as-a-Service (for example, an end-to-end AI/ML service via a user plane) for use cases, such as a self-organizing network (SON), minimization of drive test (MDT), quality of experience (QoE), positioning, sensing, predictive mobility, or traffic prediction, among other examples). In some examples, AI-as-a-Service use cases may include measurement collection reporting by a UE 120, device selection criteria (for example, according to a geographical area where measurements are to be collected or UE capabilities to be used to collected measurements), or reporting configurations (for example, reporting parameters such as location, time, or sensor information, among other examples). Additionally, or alternatively, the AI/ML model(s) may enable AI/ML procedures (for example, RAN-triggered service establishment, configuration, inferencing using UE-side or network-side models, performance monitoring or management, or capability signaling, among other examples). Additionally, or alternatively, the AI/ML model(s) may enable RAN-based AI/ML services via one or more application program interfaces (APIs) or management interfaces for use cases, such as beam management, radio resource monitoring (RRM) relaxation, mobility prediction, load prediction, network energy savings, or coverage and capacity improvements, among other examples).

In some aspects, the UE 120 may include a communication manager 150. As described in more detail elsewhere herein, the communication manager 150 may receive, from a network node 110, a configuration that indicates a set of sequences associated with PUCCH communications in accordance with a metric associated with the set of sequences satisfying a threshold associated with a channel frequency selectivity; and transmit, to the network node 110, a PUCCH message in accordance with the set of sequences. Additionally, or alternatively, the communication manager 150 may perform one or more other operations described herein.

In some aspects, the network node 110 may include a communication manager 155. As described in more detail elsewhere herein, the communication manager 155 may transmit, to a UE 120, a configuration that indicates a set of sequences associated with PUCCH communications in accordance with a metric associated with the set of sequences satisfying a threshold associated with a channel frequency selectivity; and receive, from the UE 120, a PUCCH message in accordance with the set of sequences. Additionally, or alternatively, the communication manager 155 may perform one or more other operations described herein.

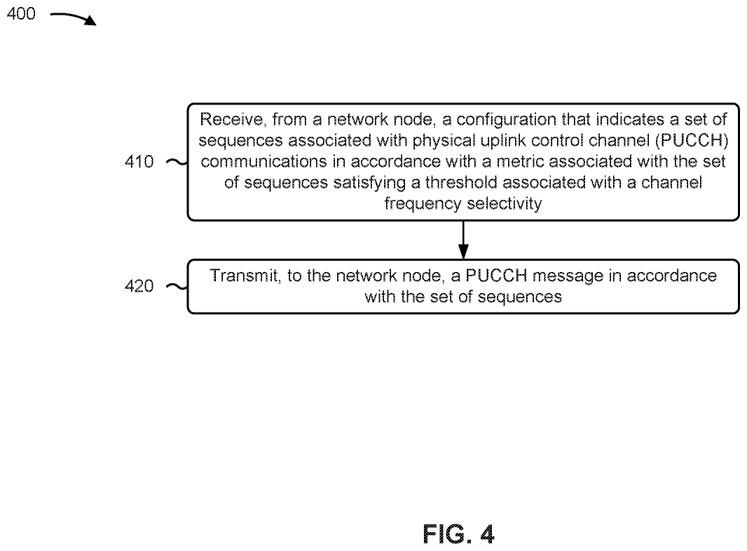

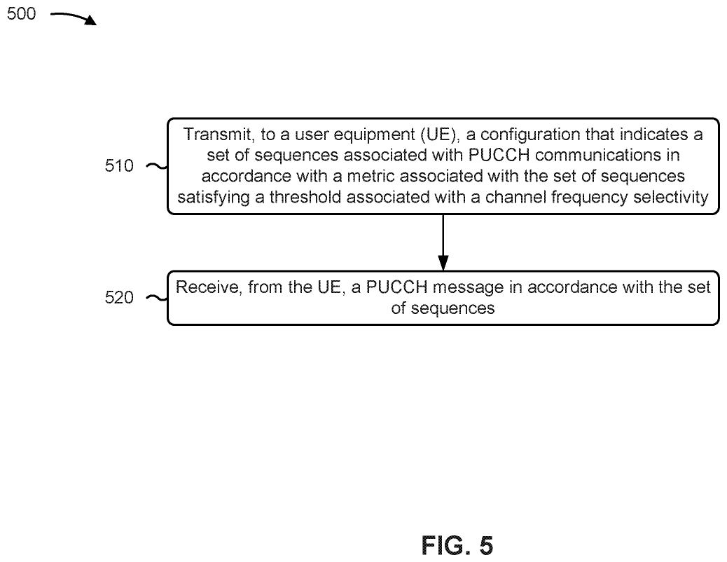

The network node 110, the processing system 145 of the network node 110, the UE 120, the processing system 140 of the UE 120, or any other component(s) of FIG. 1 may implement one or more techniques or perform one or more operations associated with evaluating PUCCH sequences to support channel frequency selectivity, as described in more detail elsewhere herein. For example, the processing system 145 of the network node 110, or the processing system 140 of the UE 120 may perform or direct operations of, for example, process 400 of FIG. 4, process 500 of FIG. 5, or other processes as described herein (alone or in conjunction with one or more other processors). Memory of the network node 110 may store data and program code (or instructions) for the network node 110. In some examples, the memory of the network node 110 may store data relating to a UE 120, such as RRC state information or a UE context. Memory of a UE 120 may store data and program code (or instructions) for the UE 120, such as context information. In some examples, the memory of the UE 120 or the memory of the network node 110 may include a non-transitory computer-readable medium storing a set of instructions for wireless communication. For example, the set of instructions, when executed by one or more processors (for example, of the processing system 145 or the processing system 140) of the network node 110, or the UE 120, may cause the one or more processors to perform process 400 of FIG. 4, process 500 of FIG. 5, or other processes as described herein. In some examples, executing instructions may include running the instructions, converting the instructions, compiling the instructions, or interpreting the instructions, among other examples.

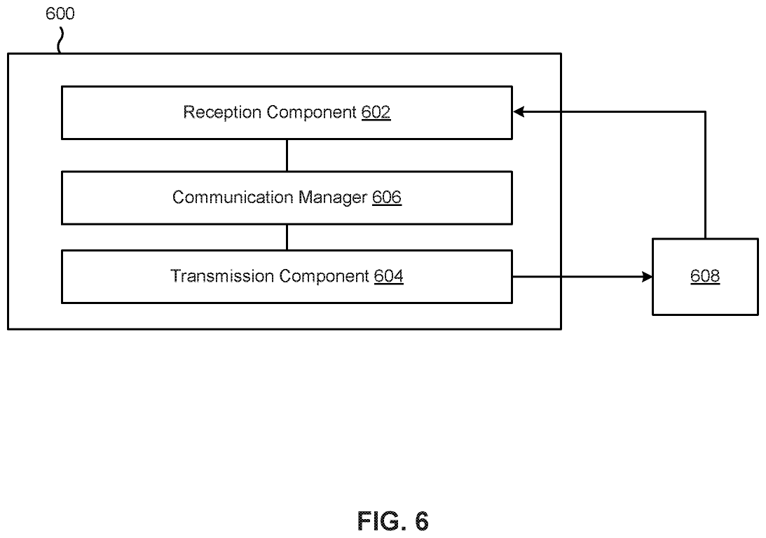

In some aspects, the UE 120 includes means for receiving, from a network node 110, a configuration that indicates a set of sequences associated with PUCCH communications in accordance with a metric associated with the set of sequences satisfying a threshold associated with a channel frequency selectivity; or means for transmitting, to the network node 110, a PUCCH message in accordance with the set of sequences. The means for the UE 120 to perform operations described herein may include, for example, one or more of communication manager 150, processing system 140, a radio, one or more RF chains, one or more transceivers, one or more antennas, one or more modems, a reception component (for example, reception component 602 depicted and described in connection with FIG. 6), or a transmission component (for example, transmission component 604 depicted and described in connection with FIG. 6), among other examples.

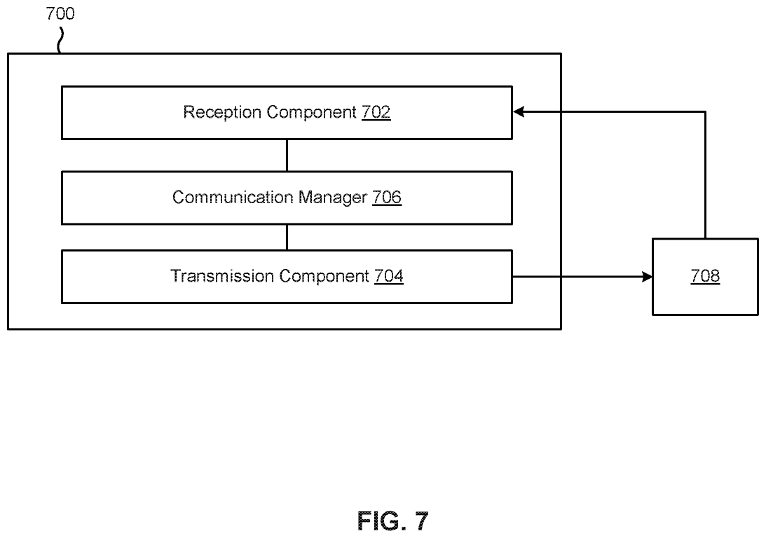

In some aspects, the network node 110 includes means for transmitting, to a UE 120, a configuration that indicates a set of sequences associated with PUCCH communications in accordance with a metric associated with the set of sequences satisfying a threshold associated with a channel frequency selectivity; or means for receiving, from the UE 120, a PUCCH message in accordance with the set of sequences. The means for the network node 110 to perform operations described herein may include, for example, one or more of communication manager 155, processing system 145, a radio, one or more RF chains, one or more transceivers, one or more antennas, one or more modems, a reception component (for example, reception component 702 depicted and described in connection with FIG. 7), or a transmission component (for example, transmission component 704 depicted and described in connection with FIG. 7), among other examples.

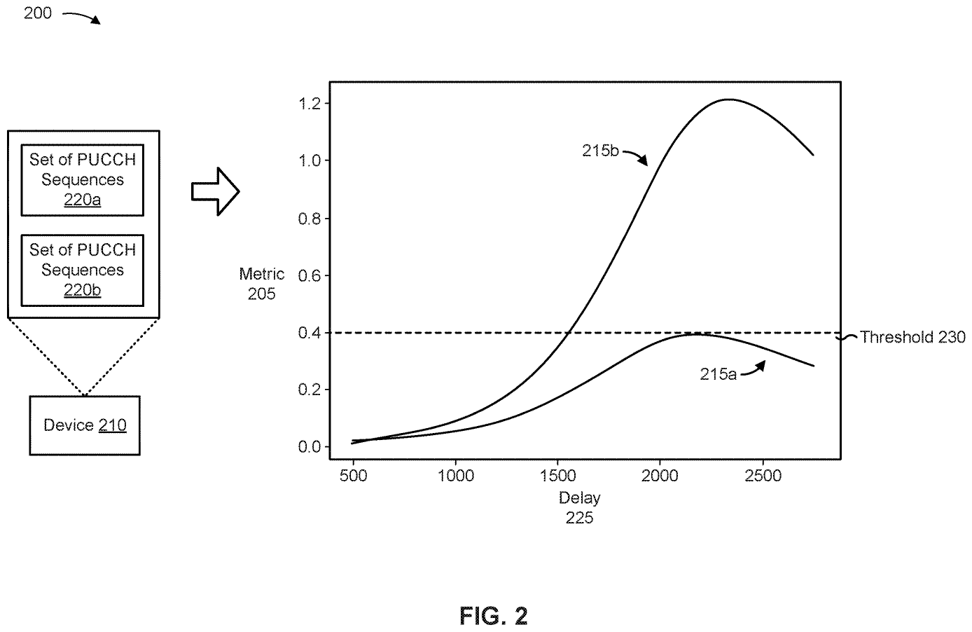

FIG. 2 is a diagram of an example 200 associated with a metric 205 for evaluating PUCCH sequences for supporting channel frequency selectivity.

In some aspects, the metric 205 described herein may be designed to evaluate the performance of PUCCH sequences in wireless communication systems, particularly under conditions of channel frequency selectivity. For example, the metric 205 may account for channel frequency selectivity, and may quantitatively assess how well different PUCCH sequences may maintain reliable communication.

In some examples, a codebook associated with a PUCCH message may be obtained by mapping each message vector having k bits (e.g., where k corresponds to a quantity of information bits for a PUCCH message) to a codeword of N_{f}Nₛ complex numbers, where N_{f} may be the quantity of REs (e.g., 12 for PUCCH format 0) and Nₛ may be a quantity of transmit ports (e.g., associated with a transmitter device, such as a UE 120). In some examples, N_{f} REs may be mapped to each port. Accordingly, the codebook may be represented by 2^{k}×2N_{f}Nₛ real values.

In some examples, a system model may be represented by Equation 2 below:

$$Y [ : , j ] = {\sum }_{l = 0}^{{N}_{s}} H [ : , k , l ] ⊙ {S}_{i} [ : , l ] + N [ : , j ] \qquad ( 2 )$$

where Y may correspond to a received signal and Y∈ [symbol] ^{N}^{_{f}}^{×N}^{ᵣ}; H may represent a PUCCH channel and H∈ [symbol] ^{N}^{_{f}}^{×N}^{ᵣ}^{×N}^{ₛ}; Sᵢ may represent a transmitted signal and Sᵢ∈ [symbol] ^{N}^{_{f}}^{×N}^{ₛ}; N∈ [symbol] ^{N}^{_{f}}^{×N}^{ᵣ}; S∈{S₀, . . . , S₂_{^{k}}₋₁}; and where Nᵣ may be a quantity of receive antennas at a device 210 (e.g., a network node 110, or another device).

In some examples, to decode a symbol, a decoder (e.g., at the network node 110) may compute a dot product of every possible received sequence Sᵢ with the conjugate of the received signal Y, and may sum a result for all transmit ports and for all receive antennas to find a value pᵢ. In some examples, this operation may be described by Equation 3 below:

$${p}_{i} = {\sum }_{j = 0}^{{N}_{r}} {\sum }_{l = 0}^{{N}_{s}} {‖ {Y [ : , j ]}^{H} {S}_{i} [ : , l ] ‖}^{2} ∀ i ∈ \{ 0 , 1 , … {2}^{k} - 1 \} \qquad ( 3 )$$

The decoder may find a receive signal for which the value of pᵢ is maximized. For example, the decoder may identify a value for i (e.g., i*) for which

$${i}^{*} = arg {max}_{i} {p}_{i} .$$

Accordingly, a decoded symbol may be given by the value of S for the identified value for i, or S_{i*}.

In some aspects, a device (e.g., the device 210) may compute a metric 205 to evaluate whether a set of PUCCH sequences satisfies a threshold associated with channel frequency selectivity. For example, the metric 205 may be computed for a channel (e.g., a PUCCH associated with a set of PUCCH sequences) having a frequency domain representation H_{τ}_{₀}, where τ₀ is a delay associated with the channel. In some examples, the channel may be a two-tap channel represented by h=a₀δ(τ)+a₁δ(τ−τ₀) in the delay domain (e.g., in a single-input, single-output setting). In some aspects, the metric 205 may be computed in accordance with Equation 4 below:

$${max}_{i , j} \frac{{‖ {S}_{i}^{H} ( {H}_{{τ}_{0}} ⊙ {S}_{j} ) ‖}^{2}}{{‖ {H}_{{τ}_{0}}^{{T}_{1}} ‖}^{2}} ∀ i \neq j \qquad ( 4 )$$

where τ₀ may be varied from a value of 0 up to a value equivalent to a cyclic prefix length associated with a numerology associated with the set of PUCCH sequences (e.g., a subcarrier spacing), and Sᵢ and Sⱼ correspond to two sequences of a pair of unique sequences of a set of PUCCH sequences.

In other words, in some aspects, the device 210 may be configured to compute the metric 205 for a set of PUCCH sequences S (which may be referred to as a lookup table) including 2^{k} sequences (e.g., S={S₀, . . . , S₂_{^{k}}₋₁}) by generating a frequency domain representation H_{τ}_{₀} of a two-tap channel h=a₀δ(τ)+a₁δ(τ−τ₀) with a second tap delay τ₀. Then, for all pairs of sequences {Sᵢ, Sⱼ}, including two unique sequences of the set of PUCCH sequences S, the device 210 may be configured to compute an elementwise multiplication of the frequency domain channel representation (e.g., H_{τ}_{₀}) with the first sequence (e.g., Sⱼ) of a respective pair of sequences (e.g., H_{τ}_{₀₁}⊙Sⱼ). In a next step, the device 210 may be configured to compute the dot product of the result of the elementwise multiplication with the conjugate of Sᵢ (e.g., Sᵢ^{H} (H_{τ}_{₀}⊙Sⱼ)).

In a following step, the device 210 may be configured to divide a squared norm of the dot product

$$( e . g . , {‖ {S}_{i}^{H} ( {H}_{{τ}_{0}} ⊙ {S}_{j} ) ‖}^{2} )$$

by a squared norm of the sum of the channel elements (e.g., ∥H_{τ}_{₀}^{T}1∥², where H_{τ}_{₀}^{T}1 may represent the sum of the channel elements) to obtain a metric value for the tuple (i, j). The device 210 may then be configured to find a maximum value for all possible pairs of unique sequences (e.g., for all values of i and j where i≠j, among

$$( \begin{matrix}{2}^{k} \\ 2\end{matrix} )$$

possible values).

As shown by FIG. 2, a curve 215 may be generated for a set of PUCCH sequences in accordance with values of the metric 205 for different delays 225 (e.g., for different values of τ₀ up to the cyclic prefix length). For example, a first curve 215a may correspond to a first set of PUCCH sequences 220a, and a second curve 215b may correspond to a second set of PUCCH sequences 220b (e.g., DFT-based sequences). In some aspects, the device 210 may be configured to calculate values for the metric 205 for all delays 225 up to a value equivalent to a cyclic prefix length (e.g., a cyclic prefix length associated with PUCCH communications). The device 210 may be configured to compare a maximum value of the metric 205 for all delays 225 to a threshold 230.

For example, a maximum value associated with the first curve 215a may satisfy the threshold 230 (e.g., in accordance with the maximum value for the first curve 215a being equal to or lower than the threshold 230). Additionally, or alternatively, a maximum value associated with the second curve 215b does not satisfy the threshold 230 (e.g., in accordance with the maximum value for the second curve 215b being larger than the threshold 230). In some aspects, the threshold 230 may be associated with a channel frequency selectivity. For example, the threshold 230 may be associated with a channel frequency selectivity configured for a PUCCH. Additionally, or alternatively, the threshold 230 may be associated with a target BER corresponding to the channel frequency selectivity. In some aspects, the device 210 may select the threshold 230, or the device 210 may be configured with the threshold 230 or receive an indication of the threshold 230 (e.g., from another device 210, such as another network node 110).

In some aspects, the metric 205 may be used to compare performances between different sets of PUCCH sequences 220. For example, as the maximum value of the metric 205 for the first curve 215a satisfies the threshold 230 and the maximum value of the metric 205 for the second curve does not satisfy the threshold 230, the computed values for the metric 205 may indicate that the first set of PUCCH sequences 220a corresponding to the first curve 215a may experience increased performance in highly frequency-selective channels relative to the second set of PUCCH sequences 220b corresponding to the second curve 215b.

By calculating values for the metric 205 derived from sequence pairs and evaluating these values against the threshold 230, the metric 205 may help in selecting the suitable sequences for PUCCH communications between a network node 110 and a UE 120. For example, the network node 110 may configure the UE 120 to perform PUCCH communications in accordance with the first set of PUCCH sequences 220a based on the metric 205. Accordingly, even in highly frequency-selective channels, the chosen sequences can achieve a desired level of communication fidelity (e.g., a target BER), thereby improving overall network performance.

As indicated above, FIG. 2 is provided as an example. Other examples may differ from what is described with respect to FIG. 2.

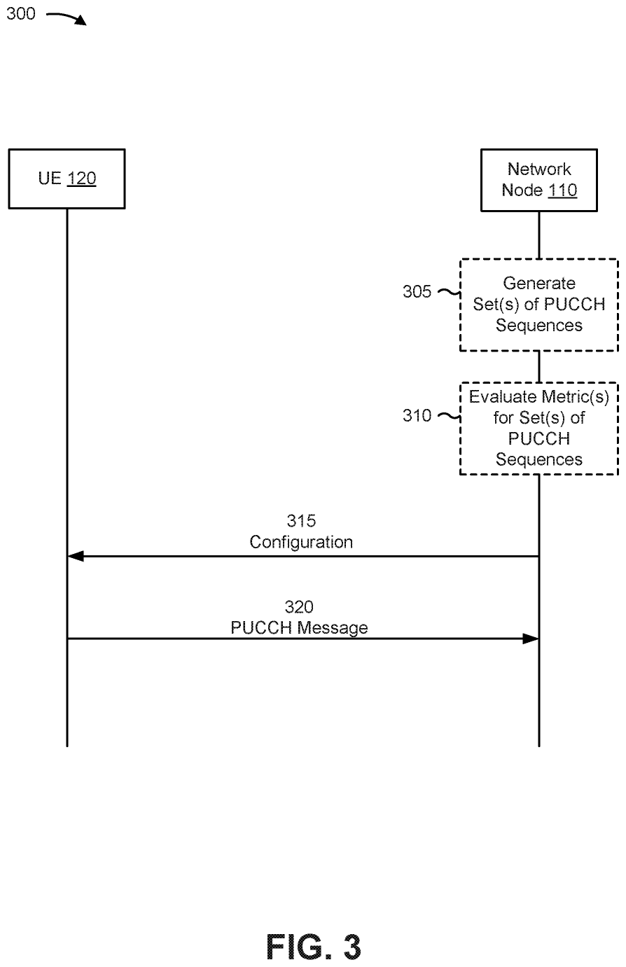

FIG. 3 is a diagram of an example 300 associated with a metric for evaluating PUCCH sequences for supporting channel frequency selectivity. As shown in FIG. 3, a network node 110 (e.g., the device 210, a base station, a CU, a DU, or an RU) may communicate with a UE 120. In some aspects, the network node 110 and the UE 120 may be part of a wireless network (e.g., the wireless communication network 100). The UE 120 and the network node 110 may have established a wireless connection prior to operations shown in FIG. 3.

In some aspects, as shown by reference number 305, the network node 110 may generate one or more sets of PUCCH sequences. For example, the network node 110 may generate multiple sets of PUCCH sequences, and each set may include 2^{k} sequences, where k may represent a quantity of information bits associated with a PUCCH communication. In some aspects, each sequence in a set of PUCCH sequences may correspond to a complex vector. In some examples, the network node 110 may use AI/ML techniques to generate the one or more sets of PUCCH sequences.

In some aspects, as shown by reference number 310, the network node 110 may evaluate the performance of each set of PUCCH sequences by evaluating a metric for each set of PUCCH sequences, as described herein with respect to FIG. 2. For example, the network node 110 may compute a maximum value of the metric from a set of values derived from unique sequence pairs within each set of PUCCH sequences. The network node 110 may compare respective maximum values for each of the one or more sets of PUCCH sequences against a threshold associated with a target BER, to assess the suitability of each set of PUCCH sequences for use in frequency-selective channels. For example, the network node 110 may select a set of PUCCH sequences that satisfies the threshold, that has a lowest maximum value for the metric, or that has a highest maximum value for the metric while satisfying the threshold.

In some aspects, as shown by reference number 315, the network node 110 may transmit, and the UE 120 may receive, a configuration. For example, the network node 110 may transmit an RRC configuration that indicates one or more selected sets of PUCCH sequences for communications with the network node 110.

In some aspects, as shown by reference number 320, the UE 120 may transmit, to the network node 110, a PUCCH message. For example, the UE 120 may use a set of PUCCH sequences indicated in the configuration to transmit the PUCCH message to the network node 110. In some examples, the PUCCH message may include HARQ information, a positive or negative SR bit, or other control information.

Accordingly, by evaluating sets of PUCCH sequences in accordance with the metric, the network node 110 may configure the UE 120 to perform PUCCH communications with enhanced communication reliability and performance even in highly frequency-selective channels, thereby reducing errors and improving overall network efficiency. Additionally, the metric may allow for the generation and evaluation of multiple sets of PUCCH sequences (e.g., generated using AI/ML techniques), which may allow the network node 110 and the UE 120 to improve selection of a set of PUCCH sequences for communications.

As indicated above, FIG. 3 is provided as an example. Other examples may differ from what is described with respect to FIG. 3. For example, some steps shown in FIG. 3 may be optional, or performed in a different order as shown. Additionally, or alternatively, some steps not shown may be added.

FIG. 4 is a diagram illustrating an example process 400 performed, for example, at a UE 120 or an apparatus of a UE 120. Example process 400 is an example where the apparatus or the UE 120 performs operations associated with evaluating PUCCH sequences to support channel frequency selectivity.

As shown in FIG. 4, in some aspects, process 400 may include receiving, from a network node, a configuration that indicates a set of sequences associated with PUCCH communications in accordance with a metric associated with the set of sequences satisfying a threshold associated with a channel frequency selectivity (block 410). For example, the UE 120 (e.g., using reception component 602 or communication manager 606, depicted in FIG. 6) may receive, from a network node, a configuration that indicates a set of sequences associated with PUCCH communications in accordance with a metric associated with the set of sequences satisfying a threshold associated with a channel frequency selectivity, as described above.

As further shown in FIG. 4, in some aspects, process 400 may include transmitting, to the network node, a PUCCH message in accordance with the set of sequences (block 420). For example, the UE 120 (e.g., using transmission component 604 or communication manager 606, depicted in FIG. 6) may transmit, to the network node, a PUCCH message in accordance with the set of sequences, as described above.

Process 400 may include additional aspects, such as any single aspect or any combination of aspects described below or in connection with one or more other processes described elsewhere herein.

In a first aspect, the set of sequences includes 2^{k} sequences, wherein the metric satisfying the threshold comprises a maximum value from a set of values evaluated from a set of sequence pairs satisfying a threshold, and wherein each sequence pair of the set of sequence pairs including two distinct sequences of the 2^{k} sequences.

In a second aspect, alone or in combination with the first aspect, each respective value of the set of values is computed in accordance with a respective elementwise multiplication of a frequency-domain channel representation with a first sequence of a respective sequence pair of the set of sequence pairs, wherein the frequency-domain channel representation includes a plurality of channel elements.

In a third aspect, alone or in combination with one or more of the first and second aspects, each respective value of the set of values is computed in accordance with a respective dot product of the respective elementwise multiplication with a conjugate of a second sequence of the respective sequence pair.

In a fourth aspect, alone or in combination with one or more of the first through third aspects, each respective value of the set of values is computed in accordance with a respective division of a squared norm of the respective dot product by a squared norm of a sum of the plurality of channel elements.

In a fifth aspect, alone or in combination with one or more of the first through fourth aspects, the maximum value is obtained from the set of values computed for a plurality of delay values associated with the frequency-domain channel representation that are lower than a cyclic prefix length satisfying the threshold.

In a sixth aspect, alone or in combination with one or more of the first through fifth aspects, the set of 2^{k} sequences are in accordance with a quantity of information bits associated with the PUCCH message, and the quantity of information bits is equal to k.

In a seventh aspect, alone or in combination with one or more of the first through sixth aspects, the set of 2^{k} sequences are in accordance with a quantity of resource elements associated with the PUCCH message, a quantity of receive antennas, and a quantity of transmission ports.

In an eighth aspect, alone or in combination with one or more of the first through seventh aspects, the configuration is received via RRC signaling.

In a ninth aspect, alone or in combination with one or more of the first through eighth aspects, the threshold is associated with a target bit error rate for the channel frequency selectivity.

Although FIG. 4 shows example blocks of process 400, in some aspects, process 400 may include additional blocks, fewer blocks, different blocks, or differently arranged blocks than those depicted in FIG. 4. Additionally, or alternatively, two or more of the blocks of process 400 may be performed in parallel.

FIG. 5 is a diagram illustrating an example process 500 performed, for example, at a network node or an apparatus of a network node. Example process 500 is an example where the apparatus or the network node (e.g., network node 110) performs operations associated with evaluating PUCCH sequences to support channel frequency selectivity.

As shown in FIG. 5, in some aspects, process 500 may include transmitting, to a UE 120, a configuration that indicates a set of sequences associated with PUCCH communications in accordance with a metric associated with the set of sequences satisfying a threshold associated with a channel frequency selectivity (block 510). For example, the network node (e.g., using transmission component 704 or communication manager 706, depicted in FIG. 7) may transmit, to a UE 120, a configuration that indicates a set of sequences associated with PUCCH communications in accordance with a metric associated with the set of sequences satisfying a threshold associated with a channel frequency selectivity, as described above.

As further shown in FIG. 5, in some aspects, process 500 may include receiving, from the UE 120, a PUCCH message in accordance with the set of sequences (block 520). For example, the network node (e.g., using reception component 702 or communication manager 706, depicted in FIG. 7) may receive, from the UE 120, a PUCCH message in accordance with the set of sequences, as described above.

Process 500 may include additional aspects, such as any single aspect or any combination of aspects described below or in connection with one or more other processes described elsewhere herein.

In a first aspect, the set of sequences includes 2^{k} sequences, wherein the metric satisfying the threshold comprises a maximum value from a set of values evaluated from a set of sequence pairs satisfying a threshold, and wherein each sequence pair of the set of sequence pairs including two distinct sequences of the 2^{k} sequences.

In a second aspect, alone or in combination with the first aspect, each respective value of the set of values is computed in accordance with a respective elementwise multiplication of a frequency-domain channel representation with a first sequence of a respective sequence pair of the set of sequence pairs, wherein the frequency-domain channel representation includes a plurality of channel elements.

In a third aspect, alone or in combination with one or more of the first and second aspects, each respective value of the set of values is computed in accordance with a respective dot product of the respective elementwise multiplication with a conjugate of a second sequence of the respective sequence pair.

In a fourth aspect, alone or in combination with one or more of the first through third aspects, each respective value of the set of values is computed in accordance with a respective division of a squared norm of the respective dot product by a squared norm of a sum of the plurality of channel elements.

In a fifth aspect, alone or in combination with one or more of the first through fourth aspects, the maximum value is obtained from the set of values computed for a plurality of delay values associated with the frequency-domain channel representation that are lower than a cyclic prefix length satisfying the threshold.

In a sixth aspect, alone or in combination with one or more of the first through fifth aspects, the set of 2^{k} sequences are in accordance with a quantity of information bits associated with the PUCCH message, and the quantity of information bits is equal to k.

In a seventh aspect, alone or in combination with one or more of the first through sixth aspects, the set of 2^{k} sequences are in accordance with a quantity of resource elements associated with the PUCCH message, a quantity of receive antennas, and a quantity of transmission ports.

In an eighth aspect, alone or in combination with one or more of the first through seventh aspects, the configuration is transmitted via RRC signaling.

In a ninth aspect, alone or in combination with one or more of the first through eighth aspects, the threshold is associated with a target bit error rate for the channel frequency selectivity.

Although FIG. 5 shows example blocks of process 500, in some aspects, process 500 may include additional blocks, fewer blocks, different blocks, or differently arranged blocks than those depicted in FIG. 5. Additionally, or alternatively, two or more of the blocks of process 500 may be performed in parallel.

FIG. 6 is a diagram of an example apparatus 600 for wireless communication. The apparatus 600 may be a UE 120, or a UE 120 may include the apparatus 600. In some aspects, the apparatus 600 includes a reception component 602, a transmission component 604, or a communication manager 606, which may be in communication with one another (for example, via one or more buses or one or more other components). In some aspects, the communication manager 606 is the communication manager 150 described in connection with FIG. 1. As shown, the apparatus 600 may communicate with another apparatus 608, such as a UE 120 or a network node 110 (such as a CU, a DU, an RU, or a base station), using the reception component 602 and the transmission component 604. The communication manager 606 may be included in, or implemented via, a processing system (for example, the processing system 140 described in connection with FIG. 1) of the UE 120.

In some aspects, the apparatus 600 may be configured to perform one or more operations described herein in connection with FIGS. 2 and 3. Additionally, or alternatively, the apparatus 600 may be configured to perform one or more processes described herein, such as process 400 of FIG. 4. In some aspects, the apparatus 600 or one or more components shown in FIG. 6 may include one or more components of the UE described in connection with FIG. 1. Additionally, or alternatively, one or more components shown in FIG. 6 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 602 may receive communications, such as reference signals, control information, data communications, or a combination thereof, from the apparatus 608. The reception component 602 may provide received communications to one or more other components of the apparatus 600. In some aspects, the reception component 602 may perform signal processing on the received communications, and may provide the processed signals to the one or more other components of the apparatus 600. In some aspects, the reception component 602 may include one or more components of the UE described above in connection with FIG. 1, such as a radio, one or more RF chains, one or more transceivers, or one or more modems, each of which may in turn be coupled with one or more antennas of the UE.

The transmission component 604 may transmit communications, such as reference signals, control information, data communications, or a combination thereof, to the apparatus 608. In some aspects, one or more other components of the apparatus 600 may generate communications and may provide the generated communications to the transmission component 604 for transmission to the apparatus 608. In some aspects, the transmission component 604 may perform signal processing on the generated communications, and may transmit the processed signals to the apparatus 608. In some aspects, the transmission component 604 may include one or more components of the UE described above in connection with FIG. 1, such as a radio, one or more RF chains, one or more transceivers, or one or more modems, each of which may in turn be coupled with one or more antennas of the UE described in connection with FIG. 1. In some aspects, the transmission component 604 may be co-located with the reception component 602.

The communication manager 606 may support operations of the reception component 602 or the transmission component 604. For example, the communication manager 606 may receive information associated with configuring reception of communications by the reception component 602 or transmission of communications by the transmission component 604. Additionally, or alternatively, the communication manager 606 may generate or provide control information to the reception component 602 or the transmission component 604 to control reception or transmission of communications.

The reception component 602 may receive, from a network node 110, a configuration that indicates a set of sequences associated with PUCCH communications in accordance with a metric associated with the set of sequences satisfying a threshold associated with a channel frequency selectivity. The transmission component 604 may transmit, to the network node 110, a PUCCH message in accordance with the set of sequences.

The number and arrangement of components shown in FIG. 6 are provided as an example. In practice, there may be additional components, fewer components, different components, or differently arranged components than those shown in FIG. 6. Furthermore, two or more components shown in FIG. 6 may be implemented within a single component, or a single component shown in FIG. 6 may be implemented as multiple, distributed components. Additionally, or alternatively, a set of (one or more) components shown in FIG. 6 may perform one or more functions described as being performed by another set of components shown in FIG. 6.

FIG. 7 is a diagram of an example apparatus 700 for wireless communication. The apparatus 700 may be a network node 110, or a network node 110 may include the apparatus 700. In some aspects, the apparatus 700 includes a reception component 702, a transmission component 704, or a communication manager 706, which may be in communication with one another (for example, via one or more buses or one or more other components). In some aspects, the communication manager 706 is the communication manager 155 described in connection with FIG. 1. As shown, the apparatus 700 may communicate with another apparatus 708, such as a UE 120 or a network node 110 (such as a CU, a DU, an RU, or a base station), using the reception component 702 and the transmission component 704. The communication manager 706 may be included in, or implemented via, a processing system (for example, the processing system 145 described in connection with FIG. 1) of the network node 110.

In some aspects, the apparatus 700 may be configured to perform one or more operations described herein in connection with FIGS. 2 and 3. Additionally, or alternatively, the apparatus 700 may be configured to perform one or more processes described herein, such as process 500 of FIG. 5. In some aspects, the apparatus 700 or one or more components shown in FIG. 7 may include one or more components of the network node 110 described in connection with FIG. 1. Additionally, or alternatively, one or more components shown in FIG. 7 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 702 may receive communications, such as reference signals, control information, data communications, or a combination thereof, from the apparatus 708. The reception component 702 may provide received communications to one or more other components of the apparatus 700. In some aspects, the reception component 702 may perform signal processing on the received communications, and may provide the processed signals to the one or more other components of the apparatus 700. In some aspects, the reception component 702 may include one or more components of the network node 110 described above in connection with FIG. 1, such as a radio, one or more RF chains, one or more transceivers, or one or more modems, each of which may in turn be coupled with one or more antennas of the network node 110. In some aspects, the reception component 702 or the transmission component 704 may include or may be included in a network interface. The network interface may be configured to obtain or output signals for the apparatus 700 via one or more communications links, such as a backhaul link, a midhaul link, or a fronthaul link.

The transmission component 704 may transmit communications, such as reference signals, control information, data communications, or a combination thereof, to the apparatus 708. In some aspects, one or more other components of the apparatus 700 may generate communications and may provide the generated communications to the transmission component 704 for transmission to the apparatus 708. In some aspects, the transmission component 704 may perform signal processing on the generated communications, and may transmit the processed signals to the apparatus 708. In some aspects, the transmission component 704 may include one or more components of the network node 110 described above in connection with FIG. 1, such as a radio, one or more RF chains, one or more transceivers, or one or more modems, each of which may in turn be coupled with one or more antennas of the network node 110 described in connection with FIG. 1. In some aspects, the transmission component 704 may be co-located with the reception component 702.

The communication manager 706 may support operations of the reception component 702 or the transmission component 704. For example, the communication manager 706 may receive information associated with configuring reception of communications by the reception component 702 or transmission of communications by the transmission component 704. Additionally, or alternatively, the communication manager 706 may generate or provide control information to the reception component 702 or the transmission component 704 to control reception or transmission of communications.

The transmission component 704 may transmit, to a UE 120, a configuration that indicates a set of sequences associated with PUCCH communications in accordance with a metric associated with the set of sequences satisfying a threshold associated with a channel frequency selectivity. The reception component 702 may receive, from the UE, a PUCCH message in accordance with the set of sequences.

The number and arrangement of components shown in FIG. 7 are provided as an example. In practice, there may be additional components, fewer components, different components, or differently arranged components than those shown in FIG. 7. Furthermore, two or more components shown in FIG. 7 may be implemented within a single component, or a single component shown in FIG. 7 may be implemented as multiple, distributed components. Additionally, or alternatively, a set of (one or more) components shown in FIG. 7 may perform one or more functions described as being performed by another set of components shown in FIG. 7.

The following provides an overview of some Aspects of the present disclosure:

Aspect 1: A method of wireless communication performed by a UE 120, comprising: receiving, from a network node 110, a configuration that indicates a set of sequences associated with PUCCH communications in accordance with a metric associated with the set of sequences satisfying a threshold associated with a channel frequency selectivity; and transmitting, to the network node 110, a PUCCH message in accordance with the set of sequences.

Aspect 2: The method of Aspect 1, wherein the set of sequences includes 2^{k} sequences, wherein the metric satisfying the threshold comprises a maximum value from a set of values evaluated from a set of sequence pairs satisfying a threshold, and wherein each sequence pair of the set of sequence pairs including two distinct sequences of the 2^{k} sequences.

Aspect 3: The method of Aspect 2, wherein each respective value of the set of values is computed in accordance with a respective elementwise multiplication of a frequency-domain channel representation with a first sequence of a respective sequence pair of the set of sequence pairs, wherein the frequency-domain channel representation includes a plurality of channel elements.

Aspect 4: The method of Aspect 3, wherein each respective value of the set of values is computed in accordance with a respective dot product of the respective elementwise multiplication with a conjugate of a second sequence of the respective sequence pair.

Aspect 5: The method of Aspect 4, wherein each respective value of the set of values is computed in accordance with a respective division of a squared norm of the respective dot product by a squared norm of a sum of the plurality of channel elements.

Aspect 6: The method of Aspect 5, wherein the maximum value is obtained from the set of values computed for a plurality of delay values associated with the frequency-domain channel representation that are lower than a cyclic prefix length satisfying the threshold.

Aspect 7: The method of any of Aspects 2-6, wherein the set of 2^{k} sequences are in accordance with a quantity of information bits associated with the PUCCH message, and wherein the quantity of information bits is equal to k.

Aspect 8: The method of Aspect 7, wherein the set of 2^{k} sequences are in accordance with a quantity of resource elements associated with the PUCCH message, a quantity of receive antennas, and a quantity of transmission ports.

Aspect 9: The method of any of Aspects 1-8, wherein the configuration is received via RRC signaling.

Aspect 10: The method of any of Aspects 1-9, wherein the threshold is associated with a target bit error rate for the channel frequency selectivity.

Aspect 11: A method of wireless communication performed by a network node 110, comprising: transmitting, to a UE 120, a configuration that indicates a set of sequences associated with PUCCH communications in accordance with a metric associated with the set of sequences satisfying a threshold associated with a channel frequency selectivity; and receiving, from the UE 120, a PUCCH message in accordance with the set of sequences.

Aspect 12: The method of Aspect 11, wherein the set of sequences includes 2^{k} sequences, wherein the metric satisfying the threshold comprises a maximum value from a set of values evaluated from a set of sequence pairs satisfying a threshold, and wherein each sequence pair of the set of sequence pairs including two distinct sequences of the 2^{k} sequences.

Aspect 13: The method of Aspect 12, wherein each respective value of the set of values is computed in accordance with a respective elementwise multiplication of a frequency-domain channel representation with a first sequence of a respective sequence pair of the set of sequence pairs, wherein the frequency-domain channel representation includes a plurality of channel elements.

Aspect 14: The method of Aspect 13, wherein each respective value of the set of values is computed in accordance with a respective dot product of the respective elementwise multiplication with a conjugate of a second sequence of the respective sequence pair.

Aspect 15: The method of Aspect 14, wherein each respective value of the set of values is computed in accordance with a respective division of a squared norm of the respective dot product by a squared norm of a sum of the plurality of channel elements.

Aspect 16: The method of Aspect 15, wherein the maximum value is obtained from the set of values computed for a plurality of delay values associated with the frequency-domain channel representation that are lower than a cyclic prefix length satisfying the threshold.

Aspect 17: The method of any of Aspects 12-16, wherein the set of 2^{k} sequences are in accordance with a quantity of information bits associated with the PUCCH message, and wherein the quantity of information bits is equal to k.

Aspect 18: The method of Aspect 17, wherein the set of 2^{k} sequences are in accordance with a quantity of resource elements associated with the PUCCH message, a quantity of receive antennas, and a quantity of transmission ports.

Aspect 19: The method of any of Aspects 11-18, wherein the configuration is transmitted via RRC signaling.

Aspect 20: The method of any of Aspects 11-19, wherein the threshold is associated with a target bit error rate for the channel frequency selectivity.

Aspect 21: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-20.

Aspect 22: An apparatus for wireless communication at a device, the apparatus comprising one or more memories and one or more processors coupled to the one or more memories, the one or more processors configured to cause the device to perform the method of one or more of Aspects 1-20.

Aspect 23: An apparatus for wireless communication, the apparatus comprising at least one means for performing the method of one or more of Aspects 1-20.

Aspect 24: A non-transitory computer-readable medium storing code for wireless communication, the code comprising instructions executable by one or more processors to perform the method of one or more of Aspects 1-20.

Aspect 25: A non-transitory computer-readable medium storing a set of instructions for wireless communication, the set of instructions comprising one or more instructions that, when executed by one or more processors of a device, cause the device to perform the method of one or more of Aspects 1-20.

Aspect 26: A device for wireless communication, the device comprising a processing system that includes one or more processors and one or more memories coupled with the one or more processors, the processing system configured to cause the device to perform the method of one or more of Aspects 1-20.

Aspect 27: An apparatus for wireless communication at a device, the apparatus comprising one or more memories and one or more processors coupled to the one or more memories, the one or more processors individually or collectively configured to cause the device to perform the method of one or more of Aspects 1-20.

Aspect 28: A device comprising a processing system that includes one or more processors and one or more code-storing memories coupled with the one or more processors, the processing system configured to cause the device to perform the method of one or more of Aspects 1-20.

Aspect 29: A device comprising a processing system that includes processor circuitry and code-storing memory circuitry, the processing system configured to cause the device to perform the method of one or more of Aspects 1-20.

Further disclosure is included in the appendix. The appendix is provided as an example only and is to be considered part of the specification. A definition, illustration, or other description in the appendix does not supersede or override similar information included in the detailed description or figures. Furthermore, a definition, illustration, or other description in the detailed description or figures does not supersede or override similar information included in the appendix. Furthermore, the appendix is not intended to limit the disclosure of possible aspects.

It will be apparent that systems or methods described herein may be implemented in different forms of hardware or a combination of hardware and software. A component being configured to perform a function means that the component has a capability to perform the function, and does not require the function to be actually performed by the component, unless noted otherwise.

As used herein, the term “determine” or “determining” can encompass one or more of a wide variety of actions. For example, “determining” can include one or more of calculating, computing, processing, deriving, detecting, estimating, investigating, looking up, inferring, ascertaining, measuring, resolving, selecting, choosing, obtaining, identifying, interpreting, demodulating, decoding, reading, establishing, forming or generating, among other examples. In some such examples, determining can involve a processor performing some type of calculating, computing, deriving, estimating, inferring, ascertaining, resolving, predicting or other processing to obtain one or more numerical values, sets, elements or other information or results. In some other such examples, determining can involve a processor identifying, looking up, investigating or otherwise obtaining some type of value, set, element or other information or result from a table, a data structure, a database or other memory device or location. In some other such examples, determining can involve a processor identifying, interpreting, demodulating, decoding, detecting, reading or otherwise obtaining some type of value, set, element or other information or result signaled in, for example, a received wireless packet. In some other such examples, determining can involve a processor selecting or choosing one or more values, sets, elements or other information or results from a larger set of values, sets elements or other information or results. In some other such examples, determining can involve a processor performing a measurement, such as on a received signal.

As used herein, the articles “a” and “an” are intended to refer to one or more items and may be used interchangeably with “one or more” or “at least one.” As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. Additionally, as used herein, a phrase referring to “a” or “an” element refers to one or more of such elements acting individually or collectively to perform the recited function(s). Additionally, as used herein, a “set” can refer to one or more items, and a “subset” can refer to a whole set or less than the whole set, but not an empty set. “Set,” “group,” and similar terms are intended to include one or more items and may be used interchangeably with “one or more.” Furthermore, as used herein, the term “or” is intended to be interpreted in the inclusive sense (such as when referring to a series) and may be used interchangeably with “and/or,” unless otherwise explicitly indicated (for example, if used in conjunction with “either” or “only one of”). For example, “A or B” may include A only, B only, or a combination of A and B. Also, as used herein, the terms “has,” “have,” “having,” “comprise,” “comprising,” “include” and “including,” and derivatives thereof or similar terms are intended to be open-ended terms that do not limit an element that they modify (for example, an element “having” A also may have B).

As used herein, the phrase “associated with” is intended to be interpreted in the inclusive sense, unless otherwise explicitly indicated. For example, the phrase “associated with” is not to be construed as a reference to a closed set of conditions, factors, criteria, elements, components, or actions, among other examples. Specifically, unless a phrase refers to “associated with only ‘a,’” or the equivalent in context, whatever it is that is “associated with ‘a,’” may be associated with “a” alone or associated with a combination of “a” and one or more other conditions, factors, criteria, elements, components, or actions, among other examples. In various examples, the phrase “associated with” may be interpreted to mean “in association with,” “in accordance with,” “based on,” “based at least in part on,” “as a function of,” “in response to,” “responsive to,” or “using” as appropriate in the relevant context unless otherwise explicitly indicated. Furthermore, what follows the phrase “associated with,” “in association with,” “in accordance with,” “based on,” “based at least in part on,” “as a function of,” “in response to,” “responsive to,” or “using” is not necessarily the focal point or primary factor associated with the limitation preceding the phrase.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. A user equipment (UE), comprising:
a processing system that includes one or more processors and one or more code-storing memories coupled with the one or more processors, the processing system configured to cause the UE to:
receive, from a network node, a configuration that indicates a set of sequences associated with physical uplink control channel (PUCCH) communications in accordance with a metric associated with the set of sequences satisfying a threshold associated with a channel frequency selectivity; and
transmit, to the network node, a PUCCH message in accordance with the set of sequences.

2. The UE of claim 1, wherein the set of sequences includes 2^{k} sequences, wherein the metric satisfying the threshold comprises a maximum value from a set of values evaluated from a set of sequence pairs satisfying a threshold, and wherein each sequence pair of the set of sequence pairs including two distinct sequences of the 2^{k} sequences.

3. The UE of claim 2, wherein each respective value of the set of values is computed in accordance with a respective elementwise multiplication of a frequency-domain channel representation with a first sequence of a respective sequence pair of the set of sequence pairs, wherein the frequency-domain channel representation includes a plurality of channel elements.

4. The UE of claim 3, wherein each respective value of the set of values is computed in accordance with a respective dot product of the respective elementwise multiplication with a conjugate of a second sequence of the respective sequence pair.

5. The UE of claim 4, wherein each respective value of the set of values is computed in accordance with a respective division of a squared norm of the respective dot product by a squared norm of a sum of the plurality of channel elements.

6. The UE of claim 5, wherein the maximum value is obtained from the set of values computed for a plurality of delay values associated with the frequency-domain channel representation that are lower than a cyclic prefix length satisfying the threshold.

7. The UE of claim 2, wherein the set of 2^{k} sequences are in accordance with a quantity of information bits associated with the PUCCH message, and wherein the quantity of information bits is equal to k.

8. The UE of claim 7, wherein the set of 2^{k} sequences are in accordance with a quantity of resource elements associated with the PUCCH message, a quantity of receive antennas, and a quantity of transmission ports.

9. The UE of claim 1, wherein the configuration is received via radio resource control (RRC) signaling.

10. The UE of claim 1, wherein the threshold is associated with a target bit error rate for the channel frequency selectivity.

11. A network node, comprising:
a processing system that includes one or more processors and one or more code-storing memories coupled with the one or more processors, the processing system configured to cause the network node to:
transmit, to a user equipment (UE), a configuration that indicates a set of sequences associated with physical uplink control channel (PUCCH) communications in accordance with a metric associated with the set of sequences satisfying a threshold associated with a channel frequency selectivity; and
receive, from the UE, a PUCCH message in accordance with the set of sequences.

12. The network node of claim 11, wherein the set of sequences includes 2^{k} sequences, wherein the metric satisfying the threshold comprises a maximum value from a set of values evaluated from a set of sequence pairs satisfying a threshold, and wherein each sequence pair of the set of sequence pairs including two distinct sequences of the 2^{k} sequences.

13. The network node of claim 12, wherein each respective value of the set of values is computed in accordance with a respective elementwise multiplication of a frequency-domain channel representation with a first sequence of a respective sequence pair of the set of sequence pairs, wherein the frequency-domain channel representation includes a plurality of channel elements.

14. The network node of claim 13, wherein each respective value of the set of values is computed in accordance with a respective dot product of the respective elementwise multiplication with a conjugate of a second sequence of the respective sequence pair.

15. The network node of claim 14, wherein each respective value of the set of values is computed in accordance with a respective division of a squared norm of the respective dot product by a squared norm of a sum of the plurality of channel elements.

16. The network node of claim 15, wherein the maximum value is obtained from the set of values computed for a plurality of delay values associated with the frequency-domain channel representation that are lower than a cyclic prefix length satisfying the threshold.

17. The network node of claim 12, wherein the set of 2^{k} sequences are in accordance with a quantity of information bits associated with the PUCCH message, and wherein the quantity of information bits is equal to k.

18. The network node of claim 17, wherein the set of 2^{k} sequences are in accordance with a quantity of resource elements associated with the PUCCH message, a quantity of receive antennas, and a quantity of transmission ports.

19. The network node of claim 11, wherein the configuration is transmitted via radio resource control (RRC) signaling.

20. A method for wireless communication performed by a user equipment (UE), comprising:
receiving, from a network node, a configuration that indicates a set of sequences associated with physical uplink control channel (PUCCH) communications in accordance with a metric associated with the set of sequences satisfying a threshold associated with a channel frequency selectivity; and
transmitting, to the network node, a PUCCH message in accordance with the set of sequences.
